(19) United States
(12) Patent Application Publication
(10) Pub. No.: US 2009/0165036 A1
(43) Pub. Date: Jun. 25, 2009

(54) Deleting two or more stored media program references based on at least one program reference attribute

(75) Inventor: Joshua Berry, Blackwood, NJ (US)

Correspondence Address: ROPES & GRAY LLP, PATENT DOCKETING 39/361, 1211 AVENUE OF THE AMERICAS, NEW YORK, NY, 10036-8704, US

(73) Assignee: Guideworks, LLC, Radnor, PA (US)

(21) Appl. No.: 12/005,042

(22) Filed: Dec. 21, 2007

(51) Int. Cl. H04N 7/10

(52) U.S. Cl. 725/32

(57) ABSTRACT

Systems and methods for deleting one or more program references (e.g., file pointer, bookmark, and reminder). Each program reference may have a value for one or more associated program reference attributes (e.g., GENRE or CONTENT RATING). A user may provide an input identifying a value for a program reference attribute, and a media system may then delete all stored program references (e.g., DVR recording handles and VOD bookmarks) having a matching value for that attribute. Values for more than one program reference attribute may be provided along with logical operators (e.g., AND, OR or XOR) for combining those values.

### BACKGROUND OF THE INVENTION

This invention is related to systems and methods for deleting stored media program references.

Some modern media entertainment systems, such as digital video recorders (DVRs), allow a user to record a particular program by directly selecting (e.g., via a program guide grid listing) the particular program for recording. On some entertainment systems, a user may be able to set-up repeat recordings which typically results in a large number and wide range of programs being stored on the system's hard drive.

Similarly, media entertainment systems may provide the ability to set bookmarks for or within recorded content. Some entertainment systems may even provide the ability to search video on demand (VOD) content libraries and set bookmarks for or within the programs in these libraries Such facility may result in a large number of bookmarks being stored on behalf of a user or users of such a system.

Other references to content, including reminders and playlists, may be stored in an entertainment system. Referring generically to recordings (e.g., by a DVR), bookmarks, reminders, playlists, and the like as media program references, it can thus be seen that in modern media entertainment systems, there are numerous ways to store a large number of media program references.

Unfortunately, to date, corresponding mechanisms for flexibly and selectively deleting media program references are virtually non-existent. In general, these mechanisms are limited to either deleting media program references one at a time or all at once. As a result, users of these systems find it time consuming and irritating to clean up DVR libraries, bookmarks, and generally any content related media program reference lists.

### SUMMARY OF THE INVENTION

Thus, the present invention is directed to systems and methods for allowing a user of a multimedia entertainment system to selectively delete one or more media program references as a function of attributes associated with the media program references.

For example, in one embodiment of the present invention, a user who wishes to delete all recordings on his DVR which belong to the series “ER” may be presented with a “delete by series” option. Upon entering the value of “ER” corresponding to the attribute SERIES (or equivalently selecting the value “ER” from a palette of radio buttons or drop down menu), the system will identify the DVR recordings which belong to the ER series and delete the references to those stored programs. In this case, a system operating according to this embodiment of the present invention provides an option for a user to input a specific value (e.g., “ER”) corresponding to a particular attribute (e.g., SERIES) and then proceeds to delete the media program references on the system whose particular attribute value matches the specific value.

In accordance with one embodiment of the present invention, a method for deleting two or more stored media program references is provided. The method comprises receiving a user input that includes an identified value or an identified range or set of values for one or more media program reference attributes. The identified value or the identified range or set is applicable to more than one but less than all stored program references on a system. The method further comprises deleting at least two stored program references in response to receiving the user input. Each deleted program reference has a value for the program reference attribute that matches the identified value or falls within the identified range or set.

In accordance with one embodiment of the present invention, a system for deleting two or more stored media program references is provided. The system comprises an input device for receiving a user input that includes an identified value or an identified range or set of values for a media program reference attribute. The identified value or the identified range or set is applicable to more than one but less than all stored program references on the system. The system further comprises control circuitry, in communication with the input device, for deleting at least two stored program references in response to receiving the user input. Each deleted program reference has a value for the program reference attribute that matches the identified value or falls within the identified range or set.

Deleting media program references by specifying the value of attributes associated with those references can have several benefits. For example, the systems and methods described herein can save a user time when deleting multiple program references that are stored within a multimedia system. In traditional systems, a user may have to manually browse through stored program references and individually evaluate stored references and related content to determine which references to delete.

### BRIEF DESCRIPTION OF THE DRAWINGS

The above and other features of the present invention, its nature and various advantages will be more apparent upon consideration of the following detailed description, taken in conjunction with the accompanying drawings, and in which:

FIG. 1 is a diagram of an illustrative interactive media system in accordance with one embodiment of the invention;

FIG. 2 is an illustrative display of a screen for logging into an interactive media guidance application in accordance with one embodiment of the invention;

FIG. 3 is an illustrative display screen showing television listings in accordance with one embodiment of the invention;

FIG. 4 is an illustrative display of an information screen in accordance with one embodiment of the invention;

FIG. 5 is an illustrative display of a program viewing screen after a recording has commenced in accordance with one embodiment of the invention;

FIG. 6 is an illustrative display of a scheduled recordings screen in accordance with one embodiment of the invention;

FIG. 7 is an illustrative display of a recordings screen in accordance with one embodiment of the invention;

FIG. 8 is an illustrative display of a disk management screen in accordance with one embodiment of the invention;

FIG. 9 is a schematic display of a data structure for storing program references in accordance with one embodiment of the invention;

FIG. 10A is an illustrative display of a generic deletion screen in accordance with one embodiment of the invention;

FIG. 10B is an illustrative display of a generic deletion screen in accordance with one embodiment of the invention;

FIG. 11 is an illustrative display of a deletion confirmation screen in accordance with one embodiment of the invention;

FIG. 12 is an illustrative display of a pre-populated deletion screen in accordance with one embodiment of the invention;

FIG. 13 is a flow chart of a method for deleting two or more stored media program references in accordance with one embodiment of the invention;

FIG. 14 is a flow chart of a method for deleting two or more stored media program references in accordance with one embodiment of the invention;

FIG. 15 is a diagram of an illustrative interactive media system in accordance with one embodiment of the invention;

FIG. 16 is an illustrative display of a stored bookmark screen in accordance with one embodiment of the invention; and

FIG. 17 is a flow chart of a method for deleting two or more stored program bookmarks in accordance with one embodiment of the invention.

### DETAILED DESCRIPTION

It should be noted that throughout this application, the term “program reference” or “media program reference” may be used to refer to one of a variety of data structures that may be associated with media programs. For example, a program reference associated with a program stored on a DVR (e.g., a DVR recording) may be a link to a block of memory where a program, game, or application is stored on a hard disk within the DVR or, in the case of a multiroom DVR system, on network accessible storage. Deleting the program reference to a program stored on a DVR may be considered synonymous with deleting the program itself for the purposes of this discussion, in the sense that deleting the program reference to a stored program implies removing the reference to the array or linked list of memory blocks where the program is stored. In some embodiments, deleting the content reference to a program stored on a DVR may include freeing the memory that was used for storing the program so that other media programs can be stored in the space that was occupied by the deleted content.

In some embodiments of the present invention, the term “program reference” may refer to a data structure associated with a media program such as a reminder or bookmark. For example, a bookmark is a type of program reference that points to a data structure that contains an identifier for the VOD program that can be used to uniquely identify the VOD program on a VOD server.

The program reference may also include information about the associated program or the program reference itself, both of which are referred to as program reference attributes. For example, the program reference for a particular program may include an offset value corresponding to a “viewed to” point within the program. The program reference may also contain other information or attributes, such as the owner(s) or user(s) associated with the reference or the priority of the reference. In some embodiments, the program reference may contain information about the content or media program referred to by the reference (e.g., the associated program). In some embodiments, the program reference may include a link to information about the associated program (e.g., title, producer, applicable genres, actors, running length, expiration date for the availability of the content on the server, and rating). In some embodiments, the reference may contain data representing information about the associated program, rather than linking to it. These attributes of the reference and/or the program to which the reference refers, may be generically referred to as media program reference attributes. Attributes of the program associated with a reference may also be referred to separately as program attributes. However, for the purposes of this discussion, all such references may be referred to herein generally as program reference attributes.

Each attribute may take on one of a group or range of values. For example, the GENRE attribute may take on a value of “western,” “comedy,” “romance,” “sports,” etc. Attribute values may be static or dynamic. For example, the attribute of GENRE for a program may typically remain constant for a program, while the attribute of OFFSET for a VOD or DVR bookmark may change as the program is viewed. Similarly, a Boolean attribute of WATCHED for a VOD program may start out with a value of “false” but the value may be modified to “true” when the user has completed viewing the program.

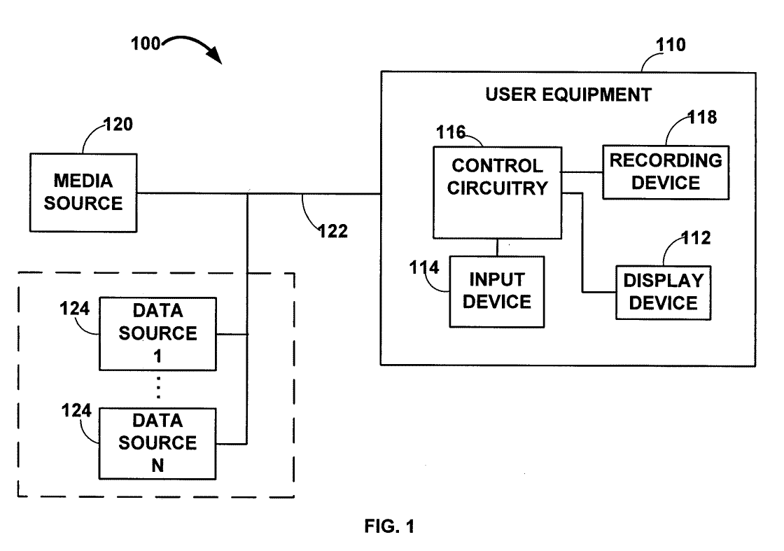

FIG. 1 is a diagram of an illustrative interactive media system 100 in accordance with one embodiment of the invention. User equipment 110 receives media in the form of signals from media source 120 over communications path 122. In practice there may be multiple media sources 120 and user equipment 110, but only one of each has been shown in FIG. 1 to avoid over-complicating the drawing.

Media source 120 may be any suitable media source such as, for example, a cable system headend, satellite media distribution facility, media broadcast facility, internet protocol television (IPTV) headend, video-on-demand server (e.g., VOD server), website, game service provider (e.g., for online gaming), or any other suitable facility or system for originating or distributing media. Media source 120 may be configured to transmit signals over any suitable communications path 122 including, for example, a satellite path, a fiber-optic path, a cable path, an Internet path, or any other suitable wired or wireless path. The signals may carry any suitable media such as, for example, television programs, games, music, news, web services, video, or any other suitable media. In some embodiments, media source 120 may include control circuitry for executing requests from a trick-play client or an interactive media guidance application implemented in, for example, user equipment 110 or a VOD server.

User equipment 110 may include any equipment suitable for providing an interactive media experience. User equipment 110 may include television equipment such as a television, set-top box, recording device, video player, user input device, or any other device suitable for providing an interactive media experience. For example, user equipment 110 may include a DCT 2000, 2500, 5100, 6208 or 6412 set-top box provided by Motorola, Inc. In some embodiments, user equipment 110 may include computer equipment, such as a personal computer with a television card (PCTV). In some embodiments, user equipment 110 may include a fixed electronic device such as, for example, a gaming system (e.g., X-Box, PlayStation, or GameCube) or a portable electronic device, such as a portable DVD player, a portable gaming device, a cellular telephone, a PDA, a music player (e.g., MP3 player), or any other suitable fixed or portable device.

In the example of FIG. 1, user equipment 110 includes at least control circuitry 116, display device 112, user input device 114, and recording device 118 which may be implemented as separate devices or as a single device. An interactive media guidance application may be implemented on user equipment 110 to provide media guidance functions to the user for media displayed on display device 112. In some embodiments, the interactive media guidance application may be or include an interactive television application, a trick-play client, or any other application for providing media features to the user.

Display device 112 may be any suitable device such as, for example, a television monitor, a computer monitor, or a display incorporated in user equipment 110 (e.g., a cellular telephone or portable music player display). Display device 112 displays the media transmitted by media source 120 over path 122, and the displays of the trick-play client. Display device 112 may also be configured to provide for the output of audio.

User input device 114 may be any suitable device for interfacing with the interactive media guidance application. For example, user input device 114 may be a remote control, keyboard, mouse, touch pad, touch screen or voice recognition interface. User input device 114 may communicate with user equipment 110 and control circuitry 116 using any suitable communications link. For example, user input device 114 may use an infra-red (IR), radio-frequency, Bluetooth, wireless (e.g., 802.11), wired, or any other suitable communications link.

Control circuitry 116 is adapted to receive user inputs from input device 114 and execute the instructions of the interactive media guidance application. Control circuitry 116 may include one or more tuners (e.g., analog or digital tuners), encoders and decoders (e.g., MPEG decoders), processors (e.g., Motorola 68000 family processors), memory 117 (e.g., RAM and hard disks), communications circuitry (e.g., cable modem circuitry), input/output circuitry (e.g., graphics circuitry), connections to the various devices of user equipment 110, and any other suitable component for providing analog or digital media programming, program recording, and interactive media guidance features. In some embodiments, control circuitry 116 may be included as part of one of the devices of user equipment 110 such as, for example, part of display device 112 or any other device (e.g., a set-top box, television and video player)

In some embodiments, media system 100 may include several recording devices 118. For the sake of clarity, however, only one is shown in FIG. 1. Recording device 118 may be a personal video recorder (PVR), digital video recorder (DVR), video cassette recorder (VCR), DVD-recorder, compact disc recorder, or any other suitable recording device(s) or storage device(s) including storage accessible via a multiroom DVR system. In some embodiments, recording device 118 may be a storage device for storing or recording content or data recorded or provided by other components of interactive media system 100 (e.g., a storage device for caching live television programs to enable trick play functions). Recording device 118 may include one or more tuners, and may be configured to cache media as the user receives it with user equipment 110 (e.g., cache the currently tuned channel) to provide trick-play functions for the user.

In some embodiments, recording device 118 may include a processor (e.g., a microcontroller or microprocessor or the like) that is used to receive and execute interactive media guidance application instructions. Recording device 118 may include memory for use when executing applications. For example, recording device 118 may include random-access memory. Nonvolatile memory may also be used to store a boot-up routine or other instructions. A hard disk and other storage in recording device 118 may be used to support databases (e.g., a database of media guidance information for recorded programs, or a database of advertisement information for recorded or cached advertisements). A hard disk or other storage in recording device 118 may also be used to record media such as television programs or video-on-demand content or other content provided to recording device 118.

In some embodiments, recording device 118 may include IR communications circuitry or other suitable communications circuitry for communicating with a remote control (e.g., with user input device 114). Recording device 118 may also include dedicated buttons and a front-panel display. The front-panel display may, for example, be used to display the current channel to which the recording device is tuned.

In some embodiments, recording device 118 may be a network recording device that is located outside of user equipment 110. In some embodiments, the network recording device may be incorporated in content source 120 (e.g., at the head-end of a cable plant), data source 124, a VOD server (not shown), user equipment 110 (e.g., as a second recording device, or a hard drive on a home computer), an Internet server, or any other suitable device. In some embodiments, the network recording device may be a stand alone device (e.g., a commercial network recording device, or a DVR device in a home or neighborhood network). The network recording device may receive instructions to perform recordings from the interactive media guidance application implemented on any of a plurality of instances of user equipment 110.

In some embodiments, the interactive media guidance application may provide features to the user with a client/server approach. There may be one server for each instance of user equipment 110, one for multiple instances of user equipment 110, or a single server may serve as a proxy for each instance of user equipment 110.

Any suitable number of users may have equipment, such as user equipment 110, connected to media source 120 and data sources 124. In some embodiments, multiple users may use a single instance of user equipment 110. A single user may also have multiple instances of user equipment 110. But for the clarity of the figure, only a single instance of user equipment 110 is shown in FIG. 1. The equipment of the plurality of users may be connected to media source 120 and data sources 124 using a cable television network, a satellite television network, a local area network (LAN), a wireless network, the Internet (e.g., using a DOCSIS modem), or any other suitable means. In some embodiments, the equipment of the plurality of users may be connected to each other using any suitable means.

User equipment 110 may receive interactive media guidance application data from one or more data sources 124. Data sources 124 may provide data for a particular type of media or for a particular application. For example, one data source 124 may provide data for non-on-demand media (e.g., non-pay and pay-per-view programs), and another may provide data for on-demand media (e.g., VOD programs). Or, for example, a single data source may provide both of these types of data. For example, one data source 124 may provide data for an interactive media guidance application. Another data source 124 may, for example, provide data for another interactive application (e.g., a home shopping application, and real-time data such as sports scores, stock quotes, news data and weather data). In some embodiments, data sources 124 may provide data to the interactive media guidance application using a client/server approach. There may be one server per data source, one for all sources or, in some embodiments, a single server may communicate as a proxy between user equipment 110 and various data sources 124. In such embodiments, data source 124 may include control circuitry for executing the instructions of the online media guidance application. In some embodiments, data source 124 may be a storage device for storing or recording content or data recorded or provided by other components of interactive media system 100 or by a content or data provider (e.g., a VOD server).

In some embodiments, data source 124 may provide advertisements (e.g., text, graphics and video advertisements for various programs, products, services, and interactive media guidance application features) to the interactive media guidance application. The advertisements may be provided by a dedicated data source, or the advertisements, along with other data, may be provided by one or more data sources.

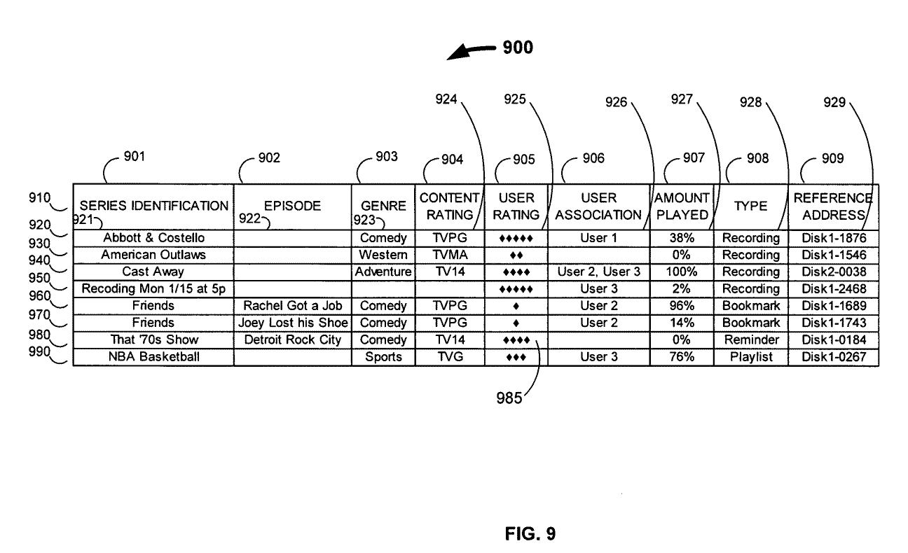

In some embodiments, data source 124 may provide information related to one or more programs. Such information may include one or more program reference attribute values that correspond to a stored program. A more detailed discussion of information that can be provided by data source 124 can be found below, for example in connection with the discussion of FIG. 9.

FIG. 1 shows media source 120 and data sources 124 as separate elements. In practice, their functionality may be combined and provided from a single system at a single facility, or multiple systems at multiple facilities. For example, one media source 120 and data source 124 may be combined to provide VOD content and associated VOD data. As another example, a separate data source 124 may be associated with each of a plurality of television broadcasters and may provide data that is specific to those broadcasters (e.g., advertisements for future programming of the broadcasters, or logo data for displaying broadcasters' logos in interactive media guidance application display screens).

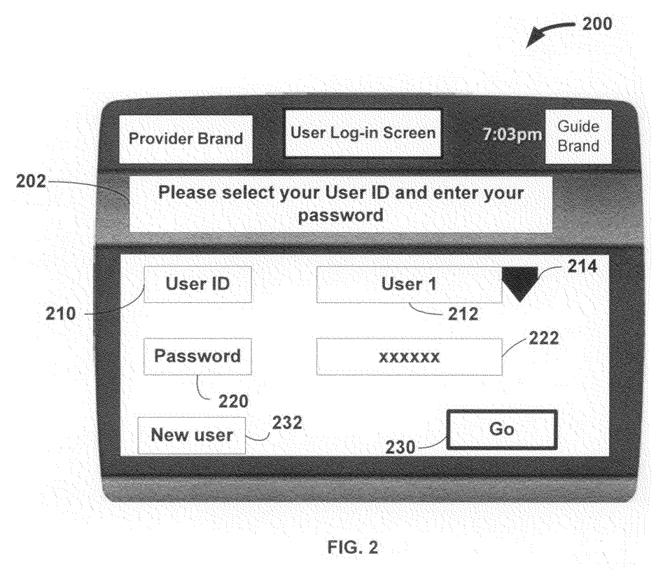

FIG. 2 is an illustrative display screen for logging in to an interactive media guidance application in accordance with one embodiment of the invention. Display screen 200 may be displayed in multi-user systems in which several users may access features of the interactive media guidance application. For example, display screen 200 may be displayed in multi-user systems in which each user may access personalized interactive media guidance application screens that may be customized for and by each user. As another example, display screen 200 may be displayed in multi-user systems in which each user may access different interactive media guidance application features (e.g., personalized recording features such as listings of recordings set up by a specific user or performed for a specific user).

Display screen 200 includes notice 202 directing a user to select a user ID and enter a password. In some embodiments, notice 202 may direct the user to enter a user ID (e.g., instead of selecting a user ID from drop down menu 212) using input device 114 (FIG. 1). Display screen 200 includes User ID tag 210, and associated drop down menu 212. The user may select or enter a user ID in menu 212 using any suitable approach, including for example entering a user ID using the keys of an input mechanism, selecting a user ID from a drop down menu (e.g., displayed in response to selecting arrow 214), or any other suitable approach. In some embodiments, the user may select an option from a drop down menu for entering a new user ID (e.g., an “other” option following existing user IDs).

If required, the user may enter a password in box 222, which is associated with password tag 220. The user may enter a password using any suitable approach, including for example entering a password key sequence using input device 114 (e.g., selecting keys on input device 114 or selecting on-screen keys corresponding to the user's password).

Once the user has selected a user ID and entered the appropriate password (if required), the user may direct the interactive media guidance application to login the user. For example, the user may press a SELECT or ENTER key or key sequence on input device 114, select on-screen GO option 230, or use any other suitable approach for providing a login instruction. If the user is new to the media system, the user may select a “New user” option (e.g., on-screen NEW USER option 232) to register. The interactive media guidance application may prompt the new user to provide a user ID, a password, preference information, or any other suitable information.

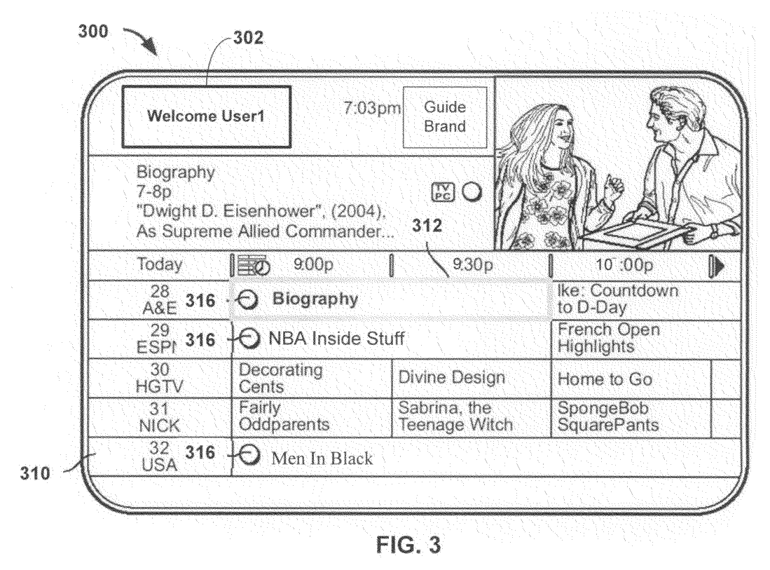

FIG. 3 is an illustrative display screen showing television listings in accordance with one embodiment of the invention. The user may access interactive media guidance application screen 300 by any suitable means such as, for example, pressing a MENU, GUIDE, or other suitable key or key sequence on user input device 114, navigating from another interactive media guidance application screen or menu, or by any other means known in the art. In multi-user systems, the interactive media guidance application may identify the currently logged in user (e.g., the user whose personalized screens and interactive media guidance application features are provided) using any suitable approach, including for example an on-screen identification (e.g., box 302).

Illustrative interactive media guidance application screen 300 includes a grid of program listings 310, which includes program titles, channels and scheduled broadcast times. The screen may include any other suitable program information. In some embodiments, the interactive media guidance application screen may include a list (e.g., a single column) of programs. The user may select a desired program listing with highlight region 312 using input device 114 (FIG. 1), or any other suitable means.

To schedule a program or other suitable video for recording, a user may highlight a desired program, as shown in FIG. 3 where “Biography” on channel 28 is highlighted, and press a RECORD key or key sequence, or select a RECORD option from the screen using user input device 114 (FIG. 1). Any suitable device from user equipment 110 (FIG. 1), for example recording device 118 (FIG. 1), may record the program. Alternatively, the program may be recorded by any other suitable device that is not part of user equipment 110. In response to receiving an instruction to record the program, the interactive media guidance application may place icon 316 on the listing associated with the selected program to indicate to the user that the interactive media guidance application has scheduled the program for recording (e.g., in FIG. 3, Biography, NBA Inside Stuff and Men In Black are scheduled for recording). In some embodiments, the interactive media guidance application may identify to the user recordings scheduled by other users (e.g., using a different icon 316).

Prior to choosing to record a program, the user may request additional information regarding the program. For example, the user may highlight a listing using highlight region 312 and press an INFORMATION key or key sequence on user input device 114. In response to receiving the user request, the interactive media guidance application may display an information screen.

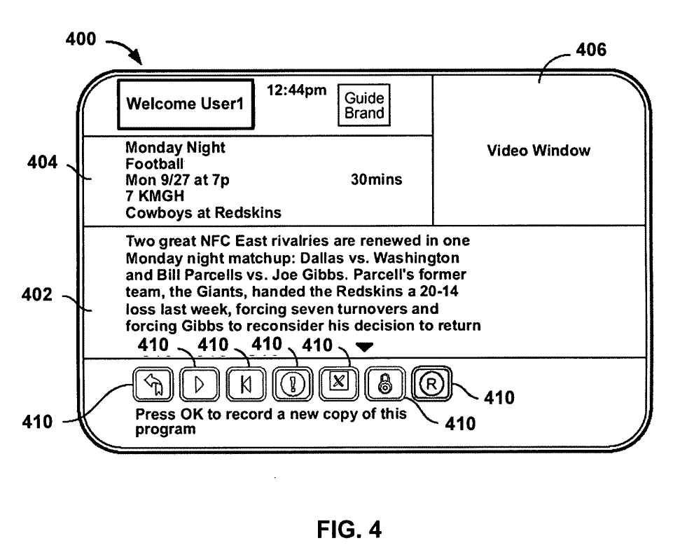

FIG. 4 is an illustrative display of an information screen in accordance with one embodiment of the invention. Information screen 400 includes detailed information section 402, program description area 404 (including the program title, time and channel), and video window 406. Screen 400 also includes selectable icons 410, some or all of which may include text descriptions. The screen may include options for recording, series recording, parental lock, or any other suitable interactive media guidance application action. If a user determines that he wants to record the program, the user may schedule the recording by pressing a RECORD key or key sequence, selecting a RECORD option from the screen using a user input device (e.g., user input device 114, FIG. 1), or by any other suitable means.

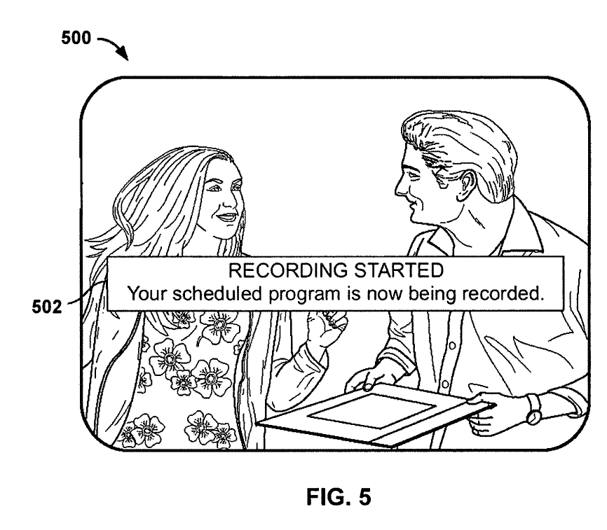

In some embodiments, the user may be watching a program on display device 112 (FIG. 1) in a full screen view, for example program viewing screen 500 shown in FIG. 5, and decide to record the program. To record the program, the user may press a RECORD key or key sequence on user input device 114 (FIG. 1), or use any other suitable means. A pop-up notice, such as pop-up notice 502, may appear to confirm that recording has begun. Such a notice may also appear in response to receiving a user confirmation to record the program). In some embodiments, pop-up notice 502 may appear automatically when a previously-scheduled recording commences.

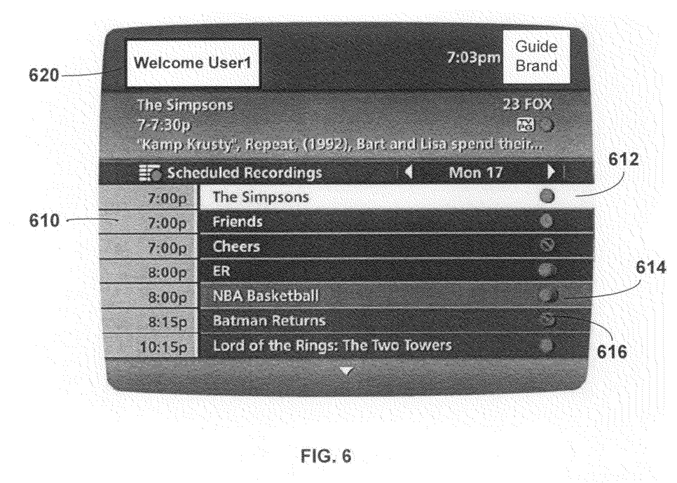

The user may view the scheduled recordings using any suitable approach. For example, the user may access a scheduled recordings screen. FIG. 6 is an illustrative display of a scheduled recordings screen in accordance with one embodiment of the invention. Screen 600 may include listings 610 of scheduled recordings. The interactive media guidance application may display listings 610 in any suitable manner, including for example by time (e.g., in the vertical direction) and by day (e.g., in the horizontal direction). In some embodiments, the interactive media guidance application may display listings 610 by channel, by program, by rating, or by any other suitable criteria. The interactive media guidance application may indicate the type of recording (e.g., series or one-time) using on-screen icons 612 and 614, respectively.

In some embodiments, the interactive media guidance application may indicate that a recording will not be performed (e.g., due to a resource conflict). For example, the interactive media guidance application may display an on-screen icon (e.g., icon 616) indicating that a recording will not be performed. In some embodiments, the interactive media guidance application may list recordings that will not be performed in a separate listing, or not list the recordings at all.

Display screen 600 may include scheduled recordings for one or more users. For example, display screen 600 may include only the recordings scheduled by the particular user currently logged in (e.g., identified in box 620). As another example, display screen 600 may include the recordings scheduled by every user. As still another example, the interactive media guidance application may allow the user to view the scheduled recordings of a subset of the users (e.g., the particular user selects whose scheduled recordings to see, or the interactive media guidance application may only allow the particular user to view scheduled recordings of users having lower priority).

The recording device may record a selected program by tuning to the channel or selecting the transport stream of the selected program, and recording all of the media that is transmitted on the channel or transport stream during the scheduled transmission time of the program. The recording device may be located in the user's equipment (e.g., a DVR), or may be a remote server to which the interactive media guidance application has access (e.g., network DVR). The recorded media may thus include the selected program, and advertisements displayed during breaks in the program (e.g., during activity breaks of a sporting event, or every 10 or 15 minutes during a traditional sitcom).

In some embodiments, the recording device may be configured to cache the programs that the user views. For example, the recording device may be configured to cache only specific channels (e.g., favorite channels), or the recording device may be configured to cache the channel that the user is watching. The cached programs may be available for playback using trick play instructions (e.g., pause, rewind, fast forward). If an entire program is stored in a cache, the recording device may save the cached program as a recording.

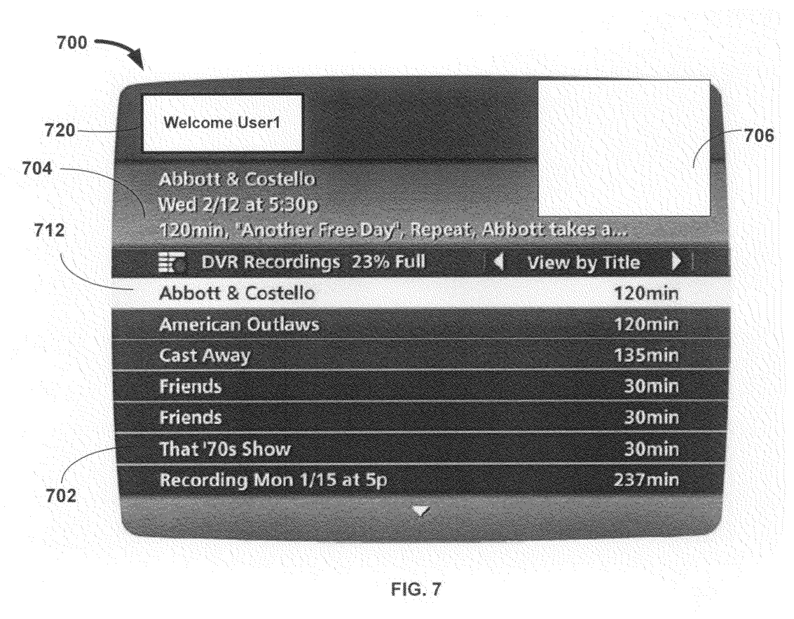

Once the recording device has recorded selected programs, the user may direct the interactive media guidance application to display listings of the recordings that the user may select for playback. For example, the user may access a recordings screen by pressing a RECORDINGS key or key sequence, navigating from another interactive media guidance application screen (e.g., selecting a RECORDINGS option from an interactive media guidance application screen using user input device 114, FIG. 1), or by any other suitable means. Recordings screen 700, shown in FIG. 7, is an illustrative display of listings of recordings performed by the media system. Screen 700 may include any suitable recording listings, including for example only the recordings scheduled by the user, recordings scheduled by all of the users, or recordings scheduled by only some users (e.g., users having lower rights, for example the children if parents are viewing recording listings). Screen 700 includes recordings listings 702, detailed information section 704 and video window 706. Listings 702 include the program title and program length. The listings may include any other suitable information (e.g., channel number or date recorded). In some embodiments, screen 700 may include listings for cached programs and listings for programs stored remotely but not recorded by the user (e.g., VOD programs), or such programs may be listed on additional, separate screens.

In some embodiments, recordings screen 700 may include recordings performed for one or more users. For example, recordings screen 700 may include only the recordings performed for the particular user currently logged in (e.g., identified in box 720). As another example, recordings screen 700 may include the recordings performed for every user. As still another example, the interactive media guidance application may allow the user to view the recordings performed for a subset of the users (e.g., the particular user selects whose recordings to see, or can only view recordings performed for users having lower priority, such as in the case of parents viewing children's recordings).

Screen 700 may indicate to the user the amount of storage space taken by the recordings. For example, the interactive media guidance application may display an indication of how much of the user's allocation has been used (e.g., how much space the user has remaining under the user's storage limit). In some embodiments, the user may view the recording device resource use of other users. As another example, the interactive media guidance application may display an indication of how much of the total space available on the recording device has been used. In some embodiments, the interactive media guidance application may display to the user (e.g., on screen 700) an indication of whether a user's storage limit may be flexibly increased (e.g., as described below).

To play back a recording, the user may select the listing (e.g., using highlight region 712) associated with the recording from listings 702 and press a PLAY key or key sequence on the user input device, select a play option from an interactive media guidance application screen, or perform any other suitable step to initiate playback. The user may alternatively press an INFORMATION key or the like to cause an information screen to be displayed (such as information screen 400 of FIG. 4) and select a PLAY icon from the information screen. In response to the user request, the interactive media guidance application may direct the user's equipment to play back the recording by, for example, directing the recording device (e.g., recording device 118) to provide the appropriate video and audio streams to the decoder and from there to a display device (e.g., display device 112) to display the selected recording. In some embodiments, users may be authorized to playback only some of the recordings (e.g., only the recordings scheduled by the user, or recordings scheduled by users having lower rights). In some embodiments, users may be authorized to play back all of the recordings.

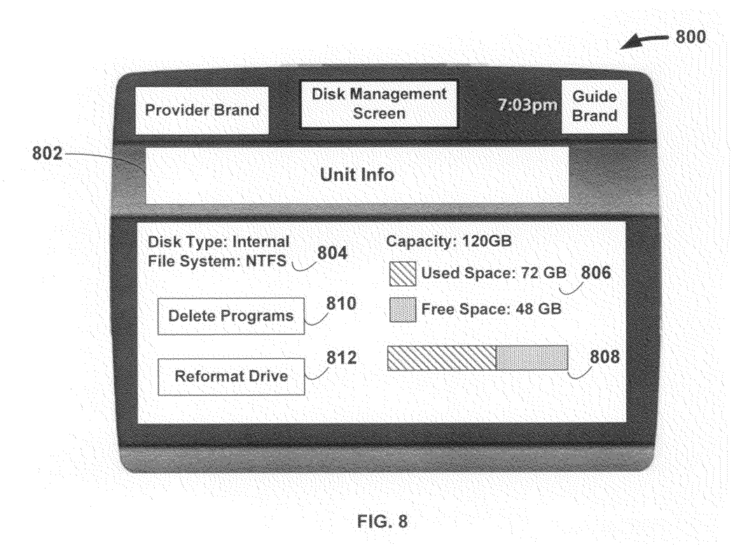

FIG. 8 is an illustrative display of a disk management screen in accordance with one embodiment of the invention. Disk management screen 800 may display general information 802 about the interactive media system (e.g., system 100) or any portion thereof (e.g., user equipment 110). General information 802 may include the model number, serial number, software version, or other suitable information.

Disk management screen 800 may display disk information 804 that can includes information about the storage (e.g., HDD) in a media system. For example, disk information 804 may include the disk type which can be used to indicate the type of storage (e.g., internal, external, flash or network) present in the system. Disk information may also include information about how files are organized in the storage (e.g., NTFS or FAT32).

Disk management screen 800 may display storage information 806 that includes information about the system's capacity for storing programs (e.g., recordings) and program references. For example, storage information 806 may include the system's total capacity, the amount of used space, and the amount of free space. In some embodiments, a visual indicator (e.g., storage bar 808) may be provided to visualize storage information 806.

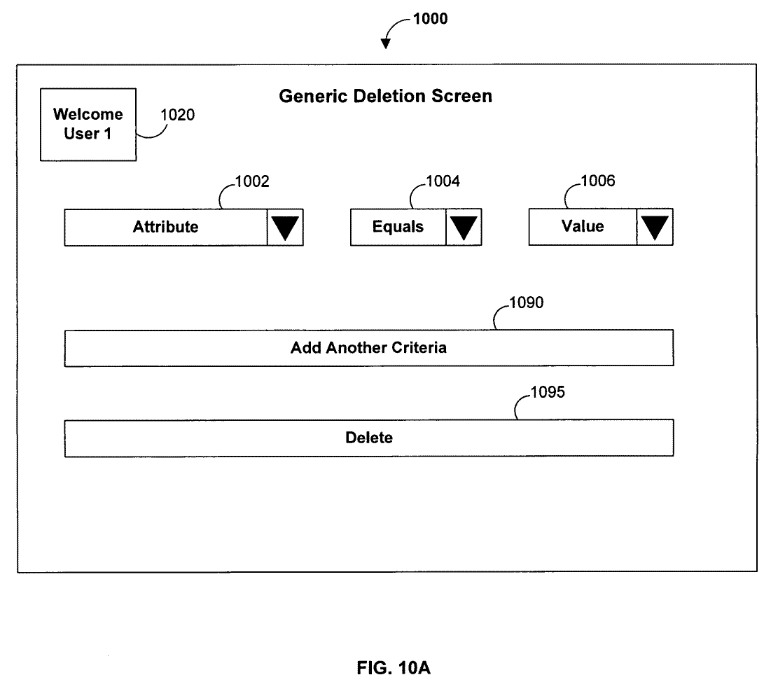

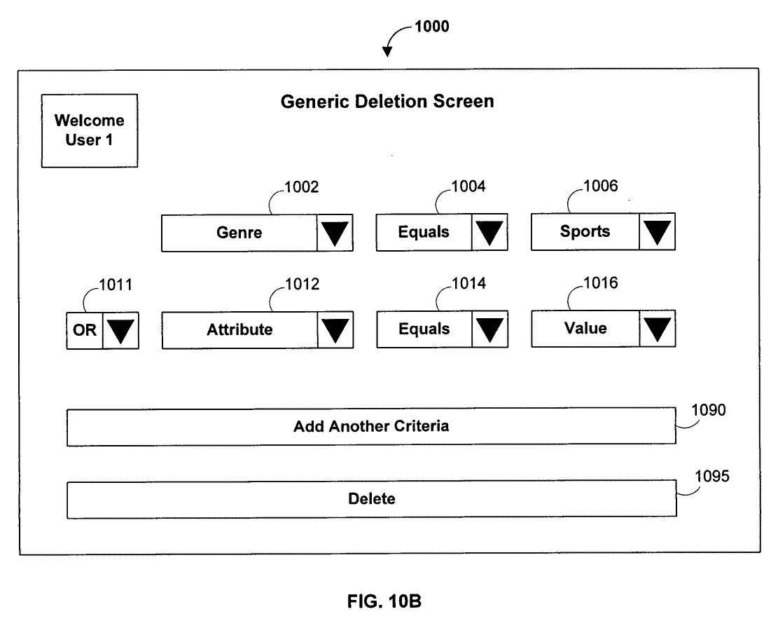

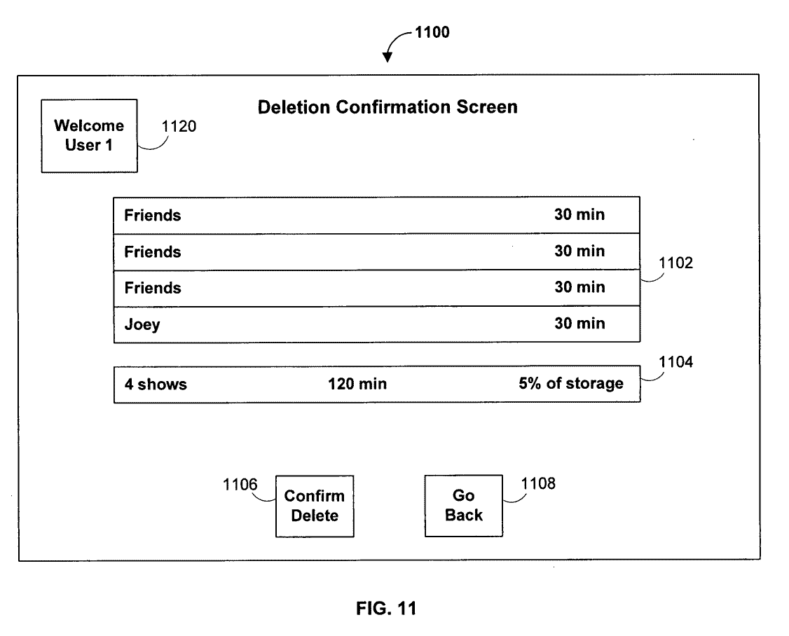

Disk management screen 800 may include one or more options that can be used to delete stored programs or program references. Upon the selection of option 810, a deletion screen may be displayed (see e.g., FIG. 10A, FIG. 10B or FIG. 11). Option 812 may be selected to initiate a process to reformat the storage. For example, after selecting option 812, the media system may erase all stored programs and/or program references.

FIG. 9 is a schematic display of data structure 900 in accordance with one embodiment of the invention. Data structure 900 includes information about program references (e.g., recordings, bookmarks, reminders or playlists), including any values corresponding to each stored reference's attributes. Data structure 900 may be stored anywhere in the interactive media system. For example, the data structure may be stored in a server remote to the user equipment (e.g., remotely stored) or in storage that is part of the user equipment (e.g., locally stored).

Data structure 900 may be organized into a table having rows and columns. Each column in data structure 900 may be used to store values for a different program reference attribute. For example, column 901 may correspond to the SERIES IDENTIFICATION attribute (e.g., a program title or a series title) and column 902 may correspond to the EPISODE attribute. First row 910 in data structure 900 may include a set of names for the attribute that is represented by each column.

Each stored program reference may be represented by an entry (e.g., a row) in the data structure. For example, data structure 900 includes rows 920, 930, 940, 950, 960, 970, 980, and 990 that are each an entry representing a stored program reference. In data structure 900, all of the program reference attribute values in each row correspond to the stored program reference represented by that row. For example, values 921-927 correspond to the stored program reference represented by row 920. In the example shown in FIG. 9, the stored program reference represented by row 920 has the title Abbott & Costello as indicated by the value “Abbot & Costello” 921 stored in the SERIES IDENTIFICATION attribute column 901.

Data structure 900 may include column 908 that can correspond to the TYPE attribute of each program reference stored in the data structure. The TYPE attribute may indicate the type (e.g., recording, bookmark, reminder, playlist) of each program reference. For example, a program reference of the recording type may refer to a recording of a program that is stored in a system. In another example, a program reference of the bookmark type may refer to a VOD program or a particular offset into a VOD program.

Data structure 900 may include column 909 that can correspond to the REFERENCE ADDRESS attribute of each program reference stored in the data structure. The REFERENCE ADDRESS attribute may indicate the location of the program associated with the reference. For example, the value of the REFERENCE ADDRESS attribute may correspond to a local or network storage device (e.g., “DISK1” in value 929) and an address on that storage device (e.g., “1876” in value 929). In some embodiments, the REFERENCE ADDRESS attribute value may point to another data structure which stores information about accessing the associated program. For example, program references of the bookmark type may have a value for a REFERENCE ADDRESS that corresponds to another data structure which stores information for accessing the associated VOD program (e.g., server address, asset address and offset). The data structure may also include other information about the VOD bookmark including the creator of the bookmark, the creation date, and an expiration date, if applicable.

In the example of data structure 900, adding a new entry may be accomplished by inserting an additional row. The process of adding a new entry to the data structure may be initiated when the system begins to store a new program reference such that the new program reference is represented by the new entry. The source of the program reference attribute values stored in each newly created entry may be provided by the media system (e.g., system 100) or a user input (e.g., an input provided through input device 114).

One or more of the attributes may have static values assigned, meaning that the attribute's value is provided when the program reference is stored and then does not typically change. For example, attributes such as SERIES IDENTIFICATION, EPISODE, GENRE, CONTENT RATING, DATE RECORDED and PROGRAM LENGTH may have static values. These static values may be provided by the interactive media system (e.g., system 100) when each program reference is stored. The static value may then be subsequently overwritten by a user in certain circumstances. For example, in some systems, a value that is typically static, such as a value of PG for the RATING attribute of a program reference, may be overwritten by a user in systems that allow user parental control rating modification. However this is the exception, since such a user specified value for RATING would more typically be stored in a separate USER SPECIFIED RATING attribute and the original rating value preserved. So, such semi-static values may still be referred to as static values because their value does not typically change after it is originally set.

Static values for attributes may be provided by one or more data sources (e.g., data sources 124) in the interactive media system. As described above in connection with FIG. 1, information (e.g., program reference attribute values) can be transmitted to the user equipment from a data source (e.g., one of data sources 124). For example, such information transmitted to the user equipment may include values for SERIES IDENTIFICATION, EPISODE or CONTENT RATING.

In some embodiments, static values for one or more of the attributes may be a portion of the media guidance application data that is used to generate a display screen (e.g., screen 300 or screen 400). The media guidance application data may be stored locally in a guide database (e.g., on user equipment 110) and may be subsequently accessed to define an attribute value (e.g., when creating a new entry in data structure 900). Accordingly, a system can limit the transmission of redundant data using locally stored data to define attribute values. In some embodiments, the media guidance application data may be streaming from a remote data source (e.g., data source 124) and a system can access this streaming data to define attribute values without interfering with the generation of display screens (e.g., screen 300 or screen 400). Similar to using locally stored data, accessing streaming data can also limit the amount of redundant transmissions.

In some embodiments, static values for one or more of the attributes may be provided by circuitry within the user equipment (e.g., control circuitry 116 or recording device 118). Such attribute values may be generated when the interactive media system is storing (e.g., recording or downloading) the program reference. These values may be available to circuitry within the user equipment because of other, inherent functions performed by the circuitry. For example, a TIMESTAMP attribute value identifying the time at which the program reference is stored may be provided by circuitry within the user equipment (e.g., a recording device). Other examples of attributes whose static values may be provided by circuitry within the user equipment include CHANNEL and LENGTH, and it is understood that the value of any suitable program reference attribute available to circuitry within the user equipment can be stored in a data structure. If the data structure is stored locally in the user equipment, providing attribute values locally from circuitry within the user equipment may limit the demands on the bandwidth of path 122.

In some embodiments, values for one or more of the attributes may be determined by analyzing one or more signals from a media source (e.g., media source 120). While a program reference associated with a program provided by a media source is being stored, the value for an attribute may be determined by analyzing a signal from the media source. In such a case, the attribute value may be inherent given the type of signal. For example, if a program is playing while the associated program reference is being stored, the value for an attribute such as RESOLUTION may be determined by analyzing a portion of the video signal from media source 120. This analysis may be performed by circuitry within the user equipment (e.g., control circuitry 116 or recording device 118). In some embodiments, the values for one or more attributes can be encoded into one or more signals from a media source.

One or more of the attributes may have values which change dynamically, meaning that the value of the attribute typically changes one or more times after the corresponding program reference has been stored. These dynamically valued attributes can provide information about the program reference that is specific to the user, including, for example, a user's rating of the associated program or the amount of the associated program that has been played by the user.

In some embodiments, the value of one or more attributes may be undefined (e.g., empty, null or blank) when the program reference is initially stored and subsequently provided by a user. These attributes may, for example, include information that the media system is not aware of. For example, the attribute USER RATING may reflect a user's opinion of the associated program, which is something that the media system may not be aware of unless the user provides it. To provide a value for this type of attribute, a user may provide an input that specifies a value for the attribute. This input may be provided through the use of an input device (e.g., input device 114).

The user may be prompted to provide such an input at any time during use of the interactive media system. Continuing the above example related to a USER RATING attribute, a user may be prompted to provide an input indicating a value for the USER RATING attribute after the associated program has been played. In some embodiments, a user may be able to navigate to an interface (e.g., recordings screen 700) where the user can select a stored program reference and provide an input with values for one or more attributes of that reference.

In some embodiments, the value of one or more attributes may be provided by the interactive media system when a program reference is initially stored and then automatically updated by the interactive media system at one or more later points in time. The value of these attributes may be considered dynamic because the value may change over time. These automatically updated attribute values may, for example, include information about the activity of the stored program reference or associated program. For example, the attribute AMOUNT PLAYED may represent the amount of the associated program that has been played. Such an attribute may be defined in units of time or as a percentage of the total program length. In this example, the value of the AMOUNT PLAYED attribute may initially be “0%.” The value may then change each time that an additional portion of the associated program is played such that, once the entire program has played, the value is “100%.” In some embodiments, the attribute LAST ACCESSED may be dynamically updated to represent the last time that the program reference was accessed or the associated program was played.

In some embodiments, one or more automatically updated attributes may include information about user associations. The value of a USER ASSOCIATION attribute may, for example, represent which users have accessed a program reference or played the associated program. Referring to FIG. 9, the program reference stored in row 940 may, for example, have a USER ASSOCIATION value signifying that User 2 and User 3 have both accessed the program reference. In some embodiments, the value of a USER ASSOCIATION attribute may represent which users have marked the program reference or associated program. Marking a program reference may include identifying the program reference for any suitable reason. For example, a program reference may be marked for easy access in the future (e.g., marking the program reference as a favorite).

It is understood that data structure 900 is merely representative and that other suitable data structures can be used without deviating from the spirit and scope of the present invention. For example, a table, stack, queue, linked list, tree, graph or any other suitable type of data structure can be used to organize the values of attributes corresponding to stored program references.

To properly manage the number of stored program references, a media system (e.g., system 100) may be able to delete one or more stored program references. In some embodiments, the system may be capable of receiving a user input and then subsequently deleting one or more stored program references in response to the received user input. The user input may include an identified value for an attribute. This identified value can be used to identify and then delete all stored program references having a value for the attribute that matches the identified value. For example, the interactive media system may receive a user input that includes the identified value of SPORTS for attribute GENRE and subsequently delete one or more stored program references having a value of SPORTS for the attribute GENRE. The deletion may occur in response to receiving the user input. In some embodiments, all stored program references having an attribute value that matches the identified value may be deleted in response to receiving the user input.

It is understood that, in addition to or in alternative to, an identified value, a user input may include an identified range of values or set of values for an attribute. After receiving such a range or set of values, the media system may delete all program references having a value for the attribute that falls within the range or matches one or more of the elements in the set. For example, a user input may include the range of sixty to one hundred percent for the attribute AMOUNT PLAYED, and the media system may subsequently delete all program references associated with programs of which a user has played sixty percent or more. In another example, a user input may include the range of Jul. 20, 2007 and earlier for the attribute DATE CREATED, and the media system may subsequently delete all program references that were created on or before Jul. 20, 2007. Ranges of values may be inclusive or exclusive with respect to their endpoints.

Additionally, values can be identified for more than one program reference attribute. Such a combination of attribute values can be used to narrow or widen the scope of program references that are deleted. In some embodiments, after receiving a user input with values for more than one attribute, the system may delete all program references having attribute values that match the identified values. For example, the system can delete all program references having the value “sports” for attribute GENRE and the value “HBO” for attribute CHANNEL. Alternatively, after receiving an input with identified values for more than one attribute, the system may delete all program references having a matching value for at least one attribute. For example, the system can delete all program references having the value “sports” for attribute GENRE or the value “HBO” for attribute CHANNEL. The manner in which multiple attributes are combined (e.g., AND, OR or XOR) may be defined by a user. For example, the manner in which multiple attributes are combined may be provided in the user input that includes the values for the attributes. The manner in which multiple attributes are combined may be defined by any logical operator (e.g., AND, OR, XOR or NAND). Moreover, the manner in which a single attribute is used to delete program references may be defined by a logical operator (e.g., EQUALS or NOT EQUALS). For example, a user input may include a single value for an attribute and the logical operator NOT EQUALS such that the system deletes all program references that do not have that value for the attribute.

Users may access a deletion screen from interactive media guidance application screen 300, information screen 400, program viewing screen 500, display screen 600, recordings screen 700, disk management screen 800 or any other suitable screen. In order to access the deletion screen, a user may alternatively provide a particular input or sequence of inputs on an input device. For example, a user may press a DELETE key or key sequence on an input device (e.g., input device 114) that corresponds to the deletion screen. In some embodiments, a user may be able to navigate a cursor (e.g., highlighted area) to an option on a screen or menu (e.g., delete program reference option 810) and select that option to access a deletion screen. In some embodiments, the user may select a listing (e.g., using highlight region 712) associated with a recording from listings 702 and press a DELETE key or key sequence on the user input device to access a deletion screen.

FIG. 10A is a generic deletion screen that may be used to input attribute values in accordance with one embodiment of the invention. Deletion screen 1000 may identify what user is currently logged into the system (e.g., in box 1020). A deletion screen may include any appropriate interface for receiving and displaying user inputs, including attribute values. For example, screen 1000 may include attribute drop down menu 1002 and value drop down menu 1006. A user may be able to navigate to attribute drop down menu 1002 and select an appropriate attribute to be used as a deletion criteria. Once an attribute has been selected, value drop down menu 1006 may be loaded with typical values for that attribute. For example, if attribute drop down menu 1002 is set to GENRE, value drop down menu 1006 may be loaded with “comedy,” “drama,” “adventure,” “sports” and any other suitable genres so that a user can select a value. If appropriate for the selected attribute, value drop down menu 1006 may include ranges of values. For example, if attribute drop down menu 1002 is set to AMOUNT PLAYED, value drop down menu 1006 may include different range options (e.g., “more than 80%” or “less than 20%”). The user can then navigate to value drop down menu 1006 and select an attribute value or range of values to be used as the deletion criteria. In some embodiments, value drop down menu 1006 may include a CUSTOM option which a user can select to define their own value or range of values for the attribute. A user may be able to define their own attribute value by using any suitable approach, including for example entering a key sequence using input device 114 (e.g., selecting keys on input device 114 or selecting on-screen keys corresponding to the value).

In some embodiments, a deletion screen may include logical operator drop down menu 1004 which can be used to define how the selected value is used to delete stored program references. For example, logical operator drop down menu 1004 may include an EQUALS option and a NOT EQUALS option. It is understood that some embodiments may, by default, delete stored program references with attribute values that match the identified value. In some embodiments, a user may not even be given the opportunity to select a logical operator. Deletion screen 1000 may include option 1090 that a user can select to add another attribute and corresponding value to be used when deleting stored program references.

FIG. 10B is a deletion screen in accordance with one embodiment of the invention. For example, FIG. 10B may show deletion screen 1000 of FIG. 10A after option 1090 has been selected. In FIG. 10B, screen 1000 includes additional attribute drop down menu 1012 and additional value drop down menu 1016. Additional logical operator drop down menu 1014 may also be displayed. These additional drop down menus may function in the same manner as the drop down menus described above such that a user can input an additional attribute and corresponding value or range of values.

Given that more than one attribute value is included in the deletion criteria, combinatorial logic operator drop down menu 1011 may be used to select how to combine the different values. For example, a user may set combinatorial logic operator drop down menu 1011 to AND, OR, XOR or any other suitable operator in order to specify how to combine the various attribute values. It is understood that some embodiments may, by default, combine multiple attribute values using the OR operator. In embodiments with a default combinatorial logic operator, a user may not even be given an opportunity to select an operator. A user may select option 1090 to display another set of drop down menus for specifying a third attribute value. It is understood that any number of attribute values can be used to delete stored program references.

After one or more attribute values have been selected, a user may select delete option 1095 to search for stored program references that match the selected values. In some embodiments, searching for stored program references may be limited, by default, to the program references associated with the currently logged in user. In other embodiments, a search may, by default, include all stored program references (e.g., a global search). In some embodiments, the user associated with a program reference may be an attribute value. For example, a user may select the USER ASSOCIATION attribute and a value of “User 2.”

FIG. 11 is a deletion confirmation screen in accordance with one embodiment of the invention. Screen 1100 may be displayed after a user has entered a deletion command (e.g., selected delete option 1095). Deletion confirmation screen 1100 may identify the currently logged in user (e.g., in box 1120). Screen 1100 may display list 1102 of stored program references with attribute values that match the one or more selected values. List 1102 may display one or more attribute values (e.g., name, length) for each program reference displayed therein. If the number of listed program references is more than can be displayed on screen 1100 at one time, a user may be able to scroll through list 1102 to see all of the program references.

Screen 1100 may display statistics 1104 about the listed program references. For example, statistics 1104 may include the number of listed program references, the combined length of the programs associated with the listed program references or the amount of storage space (e.g., a percentage) used by the listed program references or the programs associated with the listed program references.

Deletion confirmation screen 1100 may include a confirm delete option that a user can select to initiate deletion of the listed program references. Screen 1100 may also include an option that a user can select to navigate to the previously displayed screen (e.g., deletion screen 1000).

It is understood that when a user initiates the deletion of program references, the associated programs may not necessarily be physically erased from a storage medium in the system. In some file systems, for example, deleting a stored program reference may involve deleting the reference such that the program (e.g., a DVR recording) can be overwritten at a later time. Continuing this example, the program may not be physically erased until that storage space is needed for another program. Accordingly, the term delete and its related forms (e.g., deleting, deletion), as used herein, include erasing a program reference such that the associated program can no longer be accessed.

In some embodiments, a user may access a pre-populated deletion screen based on a currently selected program reference. For example, when a user is watching a program or navigating a list of program references the user may be able to access a deletion screen that is pre-populated with deletion options based on the selected program reference. Such a deletion screen may include options such as delete all program references having the same GENRE or delete all program references from the same CHANNEL, or delete all program references from the same SERIES, for example.

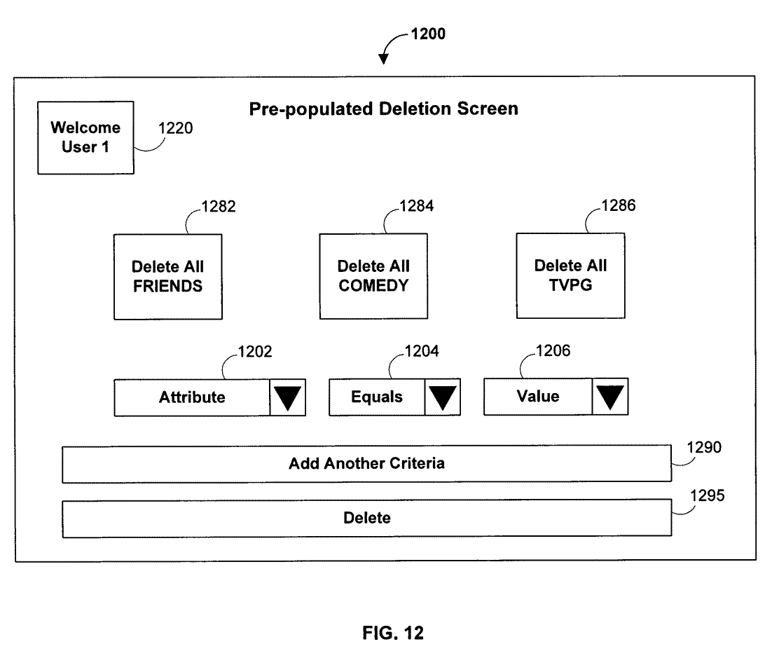

FIG. 12 is a pre-populated deletion screen in accordance with one embodiment of the invention. Screen 1200 may be similar to generic deletion screen 1000 and include many of the same features (e.g., box 1120, attribute drop down menu 1002, value drop down menu 1006). However, pre-populated deletion screen 1200 may include a series of deletion options that are based on the selected program reference when a user accessed the screen. For example, a user may provide an input to access a pre-populated deletion screen from screen 300, screen 400, screen 500, screen 600, screen 700 or any other suitable screen. In each case, attribute values from the program reference that is selected at the time that the pre-populated deletion screen is accessed can be used to pre-populate various deletion options. It is understood that in the case of screen 500, the selected program reference may be the reference associated with the program being viewed.

Pre-populated deletion screen 1200 includes delete common SERIES IDENTIFICATION option 1282, delete common GENRE option 1284 and delete common CONTENT RATING option 1286. In FIG. 12, options 1282, 1284 and 1286 were generated based on the previously selected program reference (e.g., an episode of “Friends”). To identify stored program references matching a deletion option, a user can select any of options 1282, 1284 or 1286. Similar to deletion screen 1000, a user may also set drop down menus 1202, 1204 and 1206 to provide custom deletion criteria and then subsequently select delete option 1295. After one of options 1282, 1284, 1286 or 1295 is selected, a user may be presented with a confirmation screen (e.g., confirmation screen 1100) to confirm the list of matching program references before they are deleted. It is understood that while FIG. 12 shows pre-populated deletion options based on SERIES IDENTIFICATION, GENRE and CONTENT RATING attributes, pre-populated deletion options can be provided based on any suitable attribute.

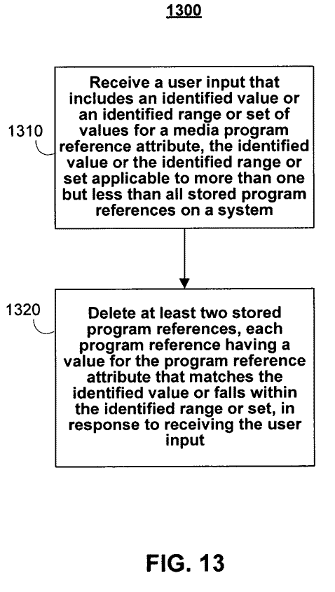

FIG. 13 is a flowchart of a method for deleting two or more stored media program references in accordance with one embodiment of the invention. Method 1300 can be performed by a media system (e.g., system 100) to delete program references from local or remote storage. At step 1310, a user input may be received that includes an identified value or an identified range or set of values for a media program reference attribute. In some embodiments, the user input may be received through an input device (e.g., input device 114). The identified value or the identified range or set may be applicable to more than one but less than all stored program references on a system. The value of the attribute for which a value, range or set of values is provided may be static. For example, the attribute may be TITLE, GENRE, SERIES IDENTIFICATION, CONTENT RATING, RECORDING DATE, LENGTH or CHANNEL. Alternatively, the value of the attribute for which a value, range or set of values is provided may be dynamic (e.g., a value that changes over time or is defined by a user). For example, the values of the attributes such as USER RATING, USER ASSOCIATION (e.g., a list of users that have accessed the program reference or a list of users that have marked the program reference), AMOUNT PLAYED or LAST ACCESSED may be dynamic. In some embodiments, a recording device's storage may be searched in response to receiving the user input. For example, storage in recording device 118 may be searched. The search may be to identify at least one stored program reference having a value for the program reference attribute that matches the identified value or falls within the identified range or set.

At step 1320, at least two stored program references may be deleted in response to receiving the user input. Each deleted program reference may have a value for the program reference attribute that matches the identified value or falls within the identified range or set. In some embodiments, a list of stored program references having a value for the attribute that matches the identified value or falls within the identified range or set may be displayed prior to deletion (e.g., using display device 112). In these embodiments, a user input may be received (e.g., through input device 114) that confirms the list of stored program references and those program references may be subsequently deleted.

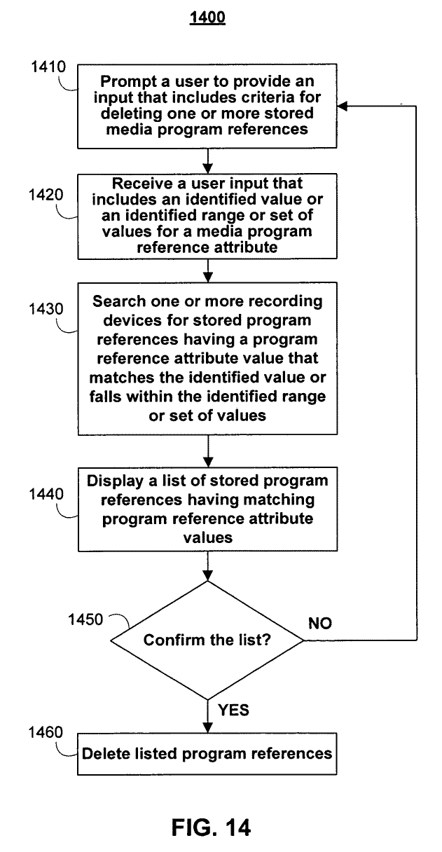

FIG. 14 is a flowchart of a method for deleting two or more stored media program references in accordance with one embodiment of the invention. Method 1400 can be performed by a media system (e.g., system 100) to delete program references from local or remote storage. At step 1410, a user may be prompted (e.g., using display device 112) to provide an input that includes criteria (e.g., attribute values) for deleting one or more stored media program references. At step 1420, a user input may be received (e.g., through input device 114) that includes an identified value or an identified range or set of values for an attribute. At step 1430, one or more recording devices (e.g., recording device 118) may be searched for stored program references having an attribute value that matches the identified value or falls within the identified range or set of values. At step 1440, a list of stored program references having matching attribute values may be displayed (e.g., through display device 112). At step 1450, a user may confirm the displayed list (e.g., using input device 114). If the user does confirm the displayed list, method 1400 may proceed with step 1460 in which the listed program references may be deleted. If the user does not confirm the displayed list, method 1400 may return to step 1410 in which a user may be prompted to provide an input that includes criteria for deleting one or more stored media program references.

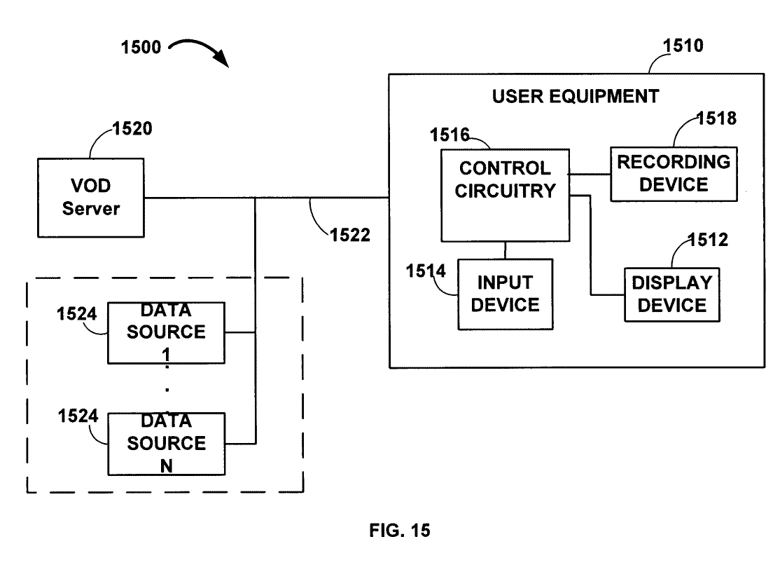

In some embodiments, an interactive media system may include a video-on-demand (VOD) server that can receive user requests and transmit the corresponding program in response. FIG. 15 shows illustrative interactive media system 1500 that includes VOD server 1520 in accordance with one embodiment of the invention. System 1500 is similar to system 100 and includes many similar components. For example, user equipment 1510, communications path 1522 and data sources 1524 may each correspond, respectively, to user equipment 110, communications path 122 and data sources 124. System 1500, however, includes VOD server 1520 which can receive a user request (e.g., from input device 1514) identifying a media program and transmit that program to user equipment 1510 in response. User equipment 1510 may then display the received program (e.g., on display device 1512). In some embodiments, a user may start and stop playback of the media program at their convenience. When a user has stopped playback of the media program, interactive media system 1500 may be used to view other programs or user equipment 1510 may be turned off. In order to easily return to the position in the program where the user had previously stopped playback, system 1500 may store a bookmark identifying that position. A bookmark is a type of program reference which can be used to access VOD programs. Such bookmarks may be stored locally (e.g., in user equipment 1510) or remotely (e.g., in VOD server 1520). In some embodiments, a media system may generate a bookmark to save a quickly accessible reference to a VOD program or to save an index into a partially viewed VOD program every time the playback of the VOD program is paused or stopped. In order to access a previously viewed VOD program, a user may navigate to a stored bookmark screen and then select the corresponding bookmark.

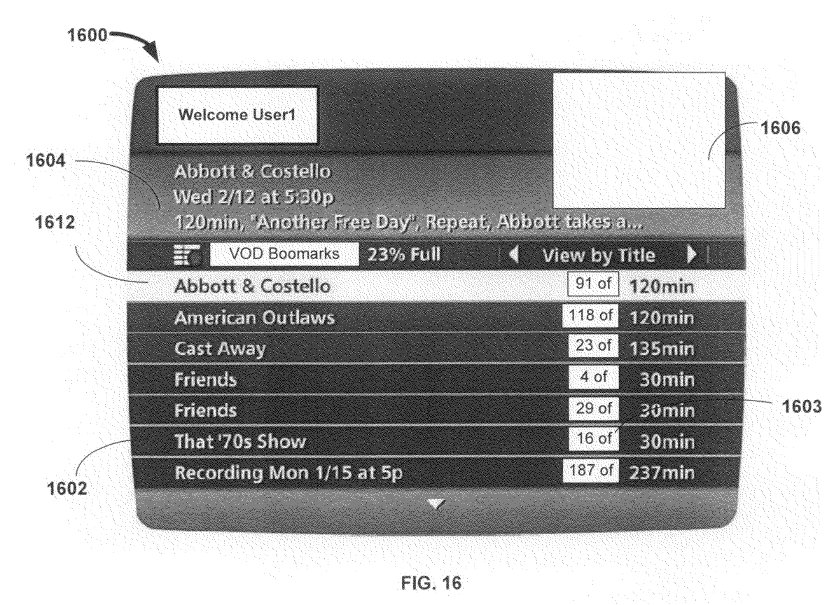

Stored bookmark screen 1600, shown in FIG. 16, is an illustrative display of a listing of stored bookmarks on a media system. Screen 1600 may be similar to recordings screen 700 and may include much of the same information. Screen 1600 may, for example, include bookmark listings 1602, detailed information section 1604 and video window 1606 which may each be similar, respectively, to recording listings 702, detailed information section 704 and video window 706. For example, each one of listings 1602 may correspond to a stored bookmark. Each listing may include suitable identification information (e.g., program title or length) for the program associated with the bookmark. Each listing may also include a measurement 1603 of the point in the program when the user stopped playback. To playback the associated program or otherwise access a bookmark, a user may select a listing (e.g., using highlight region 1612) on screen 1600. As the number of stored bookmarks increases, it may become time consuming for a user to find a particular bookmark. Additionally, each stored bookmark may occupy storage space that can be used for other purposes. For these reasons, it may be advantageous to use the above systems and methods for deleting two or more stored bookmarks according to one or more attribute values.

In some embodiments, a data structure (e.g., structure 900) may be used to store attribute values that correspond to bookmarks. For example, each entry in the data structure may correspond to a stored bookmark and may include attribute values for that bookmark. A media system (e.g., system 1500) can then accept a user input (e.g., using input device 1514) that includes one or more attribute values and subsequently delete one or more stored bookmarks in response to receiving the input. A system may display a deletion screen (e.g., generic deletion screen 1000 or pre-populated deletion screen 1200) for a user to provide an input (e.g., through input device 1514) that includes one or more attribute values. In some embodiments, the user's input may also include logical operators (e.g., AND, OR or XOR) that specify how to combine the one or more attribute values. After providing the deletion criteria, a user may instruct the media system to delete one or more stored bookmarks based on the deletion criteria. In some embodiments, a system may display a deletion confirmation screen (e.g., screen 1100) to a user and the user can provide confirmation before the matching bookmarks are deleted. It is understood that all of the functionality described above in connection with deleting stored program references based on attribute values may be applied to deleting stored bookmarks based on attribute values.

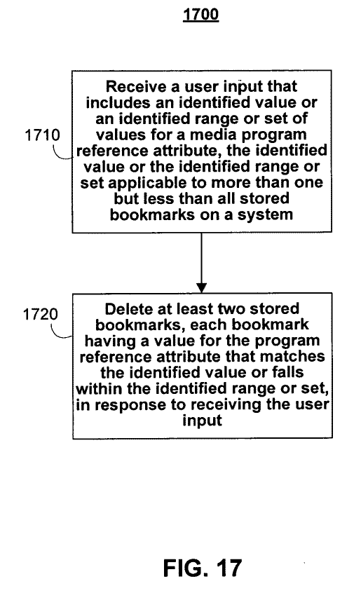

FIG. 17 is a flowchart of a method for deleting two or more stored media program bookmarks in accordance with one embodiment of the invention. Method 1700 can be performed by a media system (e.g., system 1500) to delete program bookmarks from local or remote storage. At step 1710, a user input may be received. The user input may include an identified value or an identified range or set of values for a media program reference attribute. To receive the user input, a screen (e.g., screen 1000 or 1200) may be displayed to a user (e.g., using display device 1512) and then a user may provide a selection (e.g., using input device 1514). The identified value or the identified range or set of values may be applicable to more than one but less than all stored bookmarks on a system.

At step 1720, at least two stored bookmarks may be deleted in response to receiving the user input. The bookmarks may be deleted from local storage (e.g., storage in user equipment 1510) or from remote storage. Each deleted bookmark may have a value for the media program reference attribute that matches the identified value or falls within the identified range.

The above described embodiments of the invention are presented for purposes of illustration and not of limitation, and the present invention is limited only by the claims which follow.

1. A method for deleting two or more stored media program references, the method comprising:
receiving a user input that includes an identified value or an identified range or set of values for a media program reference attribute, the identified value or the identified range or set applicable to more than one but less than all stored media program references on a system; and
deleting at least two stored media program references, each program reference having a value for the program reference attribute that matches the identified value or set of values, or falls within the identified range, in response to receiving the user input.

2. The method of claim 1, wherein:
the receiving comprises receiving a user input that includes at least a first specified value corresponding to a first specified attribute and a second specified value corresponding to a second specified attribute; and
the deleting comprises deleting at least one stored program reference having both the first and second specified attributes, wherein:
the value for first attribute of the stored program reference matches the first specified value, and
the value for second attribute of the stored program reference matches the second specified value.

3. The method of claim 1, further comprising:
displaying a list of stored program references, each program reference on the list having a value for the program reference attribute that matches the identified value or set of values, or falls within the identified range; and
receiving a user input confirming the list of stored program references, wherein the deleting is performed in response to receiving the user input confirming the list of stored program references.

4. The method of claim 1, wherein the program reference attribute is selected from the group consisting of:
title;
genre;
series identification;
content rating;
recording date;
length; and
channel.

5. The method of claim 1, wherein a value for the program reference attribute of at least one media program reference is defined by a user.

6. The method of claim 5, wherein the program reference attribute is a user rating.

7. The method of claim 1, wherein the program reference attribute is a user association.

8. The method of claim 7, wherein the value for the user association of at least one media program reference is a list of users that have accessed the program reference.

9. The method of claim 7, wherein a value for the user association of at least one media program reference is a list of users that have marked the program reference.

10. The method of claim 1, wherein a value for the program reference attribute of at least one media program reference is based on the play history of a program associated with the reference.

11. The method of claim 1, wherein a value for the program reference attribute of at least one media program reference is based on the amount that a program associated with the reference has been played.

12. The method of claim 1, wherein the at least one of the at least two stored media program references are stored on a recording device local to a user's equipment.

13. The method of claim 1, wherein at least one of the at least two stored media program references are stored on a server remote from a user's equipment.

14. A system for deleting two or more stored media program references, the system comprising:
an input device for receiving a user input that includes an identified value or an identified range or set of values for a media program reference attribute, the identified value or the identified range or set applicable to more than one but less than all stored media program references on the system; and
control circuitry, in communication with the input device, for deleting at least two stored media program references, each program reference having a value for the program attribute that matches the identified value or set of values, or falls within the identified range, in response to receiving the user input.

15. The system of claim 14, further comprising:
a recording device, electrically coupled with the control circuitry, for storing one or more media program references.

16. The system of claim 15, wherein the recording device is local to the control circuitry.

17. The system of claim 15, wherein the recording device is remote from the control circuitry.

18. The system of claim 15, wherein the recording device includes a data structure for storing media program references and values for the media program reference's attributes.

19. The system of claim 14, further comprising:
a display device, electrically coupled with the control circuitry, for displaying a list of stored media program references, each program reference on the list having a value for the program attribute that matches the identified value or set of values, or falls within the identified range.

20. The system of claim 19, wherein the input device receives a user input confirming the list.

21-33. (canceled)
